(19) United States
(12) Patent Application Publication
(10) Pub. No.: US 2007/0100641 A1
(43) Pub. Date: May 3, 2007

(54) A method and system for improving the financial success and financing options of film production

(76) Inventor: Scott Warner, Sudbury, MA (US)

Correspondence Address: SCOTT WARNER, 17 PINE HILL LANE, SUDBURY, MA, 01776, US

(21) Appl. No.: 11/163,125

(22) Filed: Oct. 5, 2005

(51) Int. Cl. G06Q 99/00

(52) U.S. Cl. 705/1

(57) ABSTRACT

A method of film development, production and financing through an Internet Web site which allows the general public to participate by casting votes for those films, in treatment form, they wish to be made and by purchasing shares of a film or other means of providing financial support. Further, the invention provides an open environment for film development in which major studios, film industry professionals, independent film talents and audience members may collaborate and participate.

### BACKGROUND OF THE INVENTION

### Field of the Invention

The present invention relates generally to film development, production and financing.

### STATEMENT OF THE PROBLEM

Tens of thousands of film projects are always under development with about six thousand produced per year. Of those, less than one hundred are widely released with only a handful of those generating healthy financial returns. Both Hollywood and independent production companies continue to search in vain for a formula to predict a film's financial outcome.

Film financing is another major problem within the industry. Only those films that are deemed to have “bankable” elements such as top actors, directors, or most often a storyline that is very similar to that of a successful past film are financed. But in realty, such bankable elements do not reliably determine a film's financial success. Funding for independent film projects is especially difficult since there are additional risks associated with these projects. Independent films usually do not achieve distribution which usually means very limited sales.

The film production industry is presently a closed environment. This keeps much of the decision making power over which films get financed, produced and distributed in the hands of a few individuals.

### SOLUTION TO THE PROBLEM

The present invention is intended to provide an open version of the industry through an Internet Web site that displays information about many film projects in various stages of development and to invite the general public to be involved in the process of determining which film projects have the best financial potential.

The present invention is intended to pre-determine a film's financial outcome based on two major factors. First, by ensuring that only those films that receive wide support from a variety of individuals who either invest money or vote for a film's production are actually produced. And secondly, once a film is produced a large number of investors from wide-ranging geographic areas will generate strong word-of-mouth publicity for the film's release.

The present invention describes a method of film development that has the following advantages:

Only those films that reach a minimum level of interest are produced. This could be measured as dollars invested or by votes or by a minimum number of investors or any combination thereof. Further, only those films that have reached a set of milestones are produced. Such milestones could include; one of more A-list actor involvement, distribution deal, A-list director, Hollywood studio co-production deal, product placement deals, and many others. The list of milestones would be attached to a film's synopsis based on the nature of the film. For example, low-budget films would likely not include an A-list talent requirement. This open environment for a film's pre-production phase provides filmmakers and investors with tools for improving the financial outcome of the project.

Potential investors can review many different film projects before deciding which to invest in. These projects will “develop” over time as milestones are reached and investment levels and interest increase. Investors may choose to invest at any stage along pre-production development path.

Film projects may be submitted by anyone and if accepted will be exposed to the community of investors, film talent and others. Such a system provides motivation for talented writers, actors, directors and other film production talents to become actively involved in this community as it develops.

Once a film is produced, the success of its theatrical and home video releases depend largely on word-of-mouth publicity. Having large numbers of geographically diverse people (perhaps in the tens of thousands) as investors of a film translates to significant and free word of mouth promotional value. For a theatrical run, the initial ticket sales in a small number of test cities often determines if a film is actively marketed and widely released by a distribution company. Having large numbers of investors will improve the likelihood of a wide theatrical release.

### DETAILED DESCRIPTION

The present invention is described as a method of doing business and a system to facilitate the method.

The system is embodied as an Internet Web site with areas accessible to everyone as well as areas only accessible to authorized users. Such authorized users are herein referred to as “members”. The Web site in its entirety is herein referred as a “portal”.

The primary purpose of the Film Production portal is to bring together the traditional individuals and entities that comprise the film production industry with those individuals and entities that are not directly involved with the industry and in many cases would have previously only been labeled as audience members.

The invention shall consist of a computer system used as a Web Server and executing the functions of the Film Production portal as herein described.

The portal application shall consist of Web pages used for the purpose of promotion, membership offerings, industry professional promotion, membership access gateway and such content as necessary to entice active participation of the portal.

The portal application shall further consist of a password protected area only accessible to those users who have been granted access through purchase of a membership or granted membership for other reasons. The protected content must necessarily evolve as the portal develops, but at a minimum the portal must include a section that allows potential investors to review film projects, cast votes and make.

A film project presented by the portal will contain, at minimum, a treatment and pre-production milestones with the current status of each. The amount of funding required to produce the film will also be indicated.

Members may choose to make an investment simply by clicking a button and entering the amount of investment desired. Such other personal information for members is collected during membership signup.

Moneys for a film production are not collected from members until the full amount required to produce the film has been committed to. Generally, moneys are collected in the form of credit card charges. If, for any reason, a film production is cancelled then all moneys collected are refunded to members unless a member has instructed otherwise.

What is claimed is:

1. A method for enhancing the financial success of a not-yet-produced film comprising the step of:
Displaying film development information such as a treatment and pre-production milestones and status of same on an Internet Web site; and
A mechanism for allowing investment in the film by individuals and entities through the sale of an unsecured share of the film.

2. A method for film production collaboration comprising the step of:
Displaying film production information such as a treatment and pre-production milestones and status of same on an Internet Web site; and
A mechanism for allowing film industry professionals to express interest in a particular film project.

3. A method of claim 3 wherein film industry professionals may become “attached” to a film project by way of committing to provide services to the project when required.

4. A method of claim 4 wherein an industry professional that becomes attached to a film project is promoted on the Web Site.

5. A method of collecting votes for various film projects comprising the step of:
Displaying film production information such as treatment and pre-production milestones and status of same on an Internet Web Site.
